(19) United States
(12) Patent Application Publication
(10) Pub. No.: US 2026/0167023 A1
(43) Pub. Date: Jun. 18, 2026

(54) VEHICLE WITH LIQUID HYDROGEN FUEL CELL ENERGY SYSTEM

(71) Applicant: Komatsu America Corp., CHICAGO, IL (US)

(72) Inventors: Kory Leesman, Peoria, IL (US); Zachary Charles Uppole, Pekin, IL (US)

(21) Appl. No.: 19/417,062

(22) Filed: Dec. 11, 2025

Related U.S. Application Data
(60) Provisional application No. 63/733,184, filed on Dec. 12, 2024.

(51) Int. Cl. B60L 50/71; B60K 15/01; B60K 15/03

(52) U.S. Cl. CPC B60L 50/71; B60K 15/01; B60K 15/03; B60K 2015/03315; B60K 2015/03427; B60L 2200/40

(57) ABSTRACT

A liquid hydrogen fuel cell power system for a vehicle includes a liquid hydrogen storage container and a heat exchanger fluidly connected to the liquid hydrogen storage container. The heat exchanger is configured to convert, e.g., vaporize, liquid hydrogen from the liquid hydrogen storage container to gaseous hydrogen. A fuel cell is fluidly connected to the heat exchanger. The fuel cell is configured to generate electrical energy from the gaseous hydrogen. The electrical energy is used to provide power to the vehicle.

### CROSS-REFERENCE TO RELATED APPLICATION

This application claims priority to and the benefit of co-pending U.S. Provisional Application No. 63/733,184, filed Dec. 12, 2024, the entire disclosure of which is hereby incorporated herein by reference.

### TECHNICAL FIELD

This disclosure relates generally to hydrogen fueled vehicles and, more particularly, to a vehicle having a liquid hydrogen fuel cell energy system.

### BACKGROUND

This section provides background information related to the present disclosure which is not necessarily prior art.

Hydrogen fuel cell electric vehicles can be more efficient than internal combustion vehicles and many electric vehicles. Hydrogen fuel cell vehicles may produce little to no harmful tailpipe emissions. Exhaust gases from a hydrogen fuel cell vehicle may include water vapor and warm air. Given the clean burning nature of hydrogen fuel, many industries are exploring options for incorporating hydrogen fuel cell vehicles into existing fleets.

In a hydrogen fuel cell vehicle, hydrogen may be stored in a tank at high pressure. The hydrogen may be passed to a gasification device which produces hydrogen gas at a reduced pressure. The hydrogen gas may then be fed to a fuel cell. The hydrogen gas may combine with oxygen in the fuel cell and a chemical reaction between the hydrogen gas and the oxygen may generate electricity. The electricity may then be stored in a battery and used to power the vehicle.

### SUMMARY

In one independent aspect, provided herein is a liquid hydrogen fuel cell power system for a vehicle. The liquid hydrogen fuel cell power system comprises a liquid hydrogen storage container, a heat exchanger fluidly connected to the liquid hydrogen storage container, and a fuel cell fluidly connected to the heat exchanger. The heat exchanger is configured to convert liquid hydrogen from the liquid hydrogen storage container to gaseous hydrogen. The fuel cell is configured to generate electrical energy from the gaseous hydrogen, and the electrical energy is used to power the vehicle.

In some aspects, the liquid hydrogen storage container includes a first potential energy, the heat exchanger includes a second potential energy, and the second potential energy is lower than the first potential energy.

In some aspects, the liquid hydrogen fuel cell power system further comprises a liquid hydrogen delivery conduit extending between the liquid hydrogen storage container and the heat exchanger. In some aspects, the liquid hydrogen is channeled through the liquid hydrogen delivery conduit from the liquid hydrogen storage container to the heat exchanger via gravity.

In some aspects, the liquid hydrogen fuel cell power system further comprises an accumulator fluidly connected between the heat exchanger and the fuel cell. In some aspects, the accumulator is configured to store the gaseous hydrogen from the heat exchanger.

In some aspects, the liquid hydrogen fuel cell power system further comprises a regulator fluidly connected between an accumulator and the fuel cell. In some aspects, the regulator is configured to control an operating parameter of the gaseous hydrogen upstream from the fuel cell.

In some aspects, the liquid hydrogen fuel cell power system further comprises a hydrogen conversion device arranged in a heat exchange relationship with the heat exchanger. In some aspects, the hydrogen conversion device is configured to facilitate converting the liquid hydrogen to the gaseous hydrogen.

In some aspects, the liquid hydrogen fuel cell power system further comprises a hydrogen conversion device comprising an electrically powered device mounted to the heat exchanger.

In some aspects, the liquid hydrogen fuel cell power system further comprises a hydrogen conversion device comprising an electrically powered device mounted to the heat exchanger, the electrically powered device comprising a Peltier device.

In some aspects, the liquid hydrogen fuel cell power system further comprises a hydrogen conversion device comprising an electrically powered device mounted to the heat exchanger, the electrically powered device being connected to a battery.

In some aspects, the liquid hydrogen fuel cell power system further comprises a hydrogen conversion device comprising an electrically powered device mounted to the heat exchanger, the electrically powered device being connected to a battery comprising a high voltage power source.

In some aspects, the liquid hydrogen fuel cell power system further comprises: a hydrogen conversion device comprising an electrically powered device mounted to the heat exchanger, the electrically powered device being connected to a battery comprising a high voltage power source; and a step down transformer electrically connected between the high voltage power source and the electrically powered device.

In some aspects, the heat exchanger is a first heat exchanger, and the liquid hydrogen fuel cell power system further comprises a second heat exchanger downstream from the first heat exchanger. In some aspects, the second heat exchanger is configured to receive unconverted liquid hydrogen from the first heat exchanger.

In some aspects, the heat exchanger is a first heat exchanger, and the liquid hydrogen fuel cell power system further comprises a second heat exchanger downstream from the first heat exchanger, the second heat exchanger being configured to receive unconverted liquid hydrogen from the first heat exchanger, and the second heat exchanger being fluidly connected to the fuel cell.

In some aspects, the heat exchanger is a first heat exchanger, and the liquid hydrogen fuel cell power system further comprises: a second heat exchanger downstream from the first heat exchanger, the second heat exchanger being configured to receive unconverted liquid hydrogen from the first heat exchanger; and a check valve positioned between the first heat exchanger and the second heat exchanger.

In some aspects, the liquid hydrogen fuel cell power system further comprises a bypass positioned between the heat exchanger and the fuel cell.

In some aspects, the liquid hydrogen fuel cell power system further comprises a pressure relief circuit fluidly connected to the heat exchanger.

In some aspects, the liquid hydrogen fuel cell power system further comprises a pressure relief circuit fluidly connected to the heat exchanger, and the pressure relief circuit includes a pressure relief valve that is operable to reduce pressure in the heat exchanger to ambient pressure.

In some aspects, the liquid hydrogen fuel cell power system further comprises: a pressure relief circuit fluidly connected to the heat exchanger, the pressure relief circuit including a pressure relief valve that is operable to reduce pressure in the heat exchanger to ambient pressure; and a controller operatively connected to the pressure relief valve and configured to operate the pressure relief valve.

In some aspects, the liquid hydrogen fuel cell power system further comprises a pressure relief circuit that fluidly connects the heat exchanger with the liquid hydrogen storage container.

In another independent aspect, provided herein is a vehicle including a liquid hydrogen fuel cell power system. The liquid hydrogen fuel cell power system comprises a liquid hydrogen storage container, a heat exchanger fluidly connected to the liquid hydrogen storage container, and a fuel cell fluidly connected to the heat exchanger. The heat exchanger is configured to convert liquid hydrogen from the liquid hydrogen storage container to gaseous hydrogen. The fuel cell is configured to generate electrical energy from the gaseous hydrogen, and the electrical energy is used to power the vehicle.

In another independent aspect, provided herein is a method of powering a vehicle. The method comprises: storing liquid hydrogen on the vehicle; channeling at least a portion of the liquid hydrogen to a heat exchanger; converting the liquid hydrogen to gaseous hydrogen via the heat exchanger; delivering the gaseous hydrogen to a fuel cell; generating electrical energy from the gaseous hydrogen via the fuel cell; and powering the vehicle with the electrical energy.

In some aspects, the method further comprises channeling the gaseous hydrogen from the heat exchanger to an accumulator.

In some aspects, the method further comprises channeling the gaseous hydrogen from the accumulator through a pressure regulator before delivery to the fuel cell.

In some aspects, converting the liquid hydrogen to the gaseous hydrogen includes raising a temperature of the liquid hydrogen via the heat exchanger.

In some aspects, converting the liquid hydrogen to the gaseous hydrogen includes raising a temperature of the liquid hydrogen via the heat exchanger, and raising the temperature of the liquid hydrogen via the heat exchanger is facilitated using an electrically powered device arranged in a heat exchange relationship with the heat exchanger.

In some aspects, converting the liquid hydrogen to the gaseous hydrogen includes raising a temperature of the liquid hydrogen via the heat exchanger, raising the temperature of the liquid hydrogen via the heat exchanger is facilitated using an electrically powered device arranged in a heat exchange relationship with the heat exchanger, and the electrically powered device includes a Peltier device.

In some aspects, converting the liquid hydrogen to the gaseous hydrogen includes raising a temperature of the liquid hydrogen via the heat exchanger, and raising the temperature of the liquid hydrogen via the heat exchanger includes channeling a heat transfer liquid in a heat exchange relationship with the heat exchanger.

In some aspects, the method further comprises cooling the heat exchanger after delivering the gaseous hydrogen to the fuel cell.

In some aspects, channeling the liquid hydrogen to the heat exchanger comprises channeling a first portion of the liquid hydrogen to a first heat exchanger and channeling a second portion of the liquid hydrogen to a second heat exchanger.

The above described aspects can be combined in any combination.

The following description and the appended figures set forth certain features for purposes of illustration. Advantages will become more apparent when reading the present disclosure in its entirety.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 is a perspective view of a vehicle including a liquid hydrogen fuel cell energy system.

FIG. 2 is a block diagram of a liquid hydrogen fuel cell energy system for a vehicle.

FIG. 3 is a block diagram of a method of powering a vehicle using a liquid hydrogen fuel cell energy system.

Corresponding reference numbers in the drawings indicate corresponding parts.

The drawings described herein are for illustrative purposes only of selected embodiments and not all possible implementations and are not intended to limit the scope of the present disclosure.

### DETAILED DESCRIPTION

The embodiments described herein are not limited to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. When introducing elements of various embodiments of the present disclosure, the articles “a,” “an,” and “the” are intended to mean that there are one or more of the elements. The use of “including,” “comprising,” or “having” and variations thereof are meant to encompass the items listed thereafter and equivalents thereof as well as additional items. References to “one embodiment” or “an embodiment” of the present disclosure are not intended to be interpreted as excluding the existence of additional embodiments that also incorporate the recited features. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects. The method steps, processes, and operations described herein are not to be construed as necessarily requiring their performance in the particular order discussed or illustrated, unless specifically identified as an order of performance. It is also to be understood that additional or alternative steps may be employed.

Unless specified or limited otherwise, the terms “mounted,” “connected,” “supported,” and “coupled” and variations thereof are used broadly and encompass both direct and indirect mountings, connections, supports, and couplings. The terms “connected,” “coupled,” and variations thereof when used in conjunction with “fluidly” are similarly used broadly and encompass both direct and indirect connections and couplings that allow fluid communication between two elements or components, optionally with one or more intermediate elements or components also in fluid communication therebetween. An element or component can be fluidly connected or fluidly coupled to another element or component directly or indirectly by one or more conduits, pipes, ducts, tubes, channels, etc. extending between the two components and optionally one or more intermediate components positioned therebetween.

The terms “upstream” and “downstream” are understood relatively to the normal direction of circulation of a fluid in a conduit.

Relative terminology, such as, for example, “about,” “approximately,” “substantially,” and the like, used in connection with a quantity or condition would be understood by those of ordinary skill to be inclusive of the stated value and has the meaning dictated by the context (for example, the term includes at least the degree of error associated with the measurement accuracy, tolerances (for example, manufacturing, assembly, use, and the like) associated with the particular value, and the like). For example, “about,” “approximately,” and/or “substantially” can include a range of ±8% of a given value.

The terms “first,” “second,” “third,” etc. may be used herein to describe various elements, components, regions, layers and/or sections in a non-limiting manner and these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “forward,” “rearward,” “front,” “rear,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Hydrogen fueled vehicles may store hydrogen fuel as a gas in a pressurized container. While stable at over a wide temperature range, storing a sufficient amount of pressurized hydrogen gas to support various vehicle types presents certain challenges. Smaller vehicles with low or modest fuel consumption may store enough fuel for longer trips. Larger vehicles, such as mining vehicles, may have a higher fuel burn rate (e.g., between about 30 kg to about 40 kg per hour, with a maximum of about 80 kg per hour). In a large mining vehicle, conventional hydrogen fuel storage tanks can only hold enough fuel for about 2.75 hours of operation. The systems and methods of this disclosure facilitate increasing fuel storage volume and reducing trips for refueling. Accordingly, the systems and methods hereof may be utilized to provide hydrogen fueled vehicles that can be practically used to harness the emission reducing technologies of hydrogen fuel cell systems without sacrificing vehicle operation.

Example embodiments will now be described more fully with reference to the accompanying drawings.

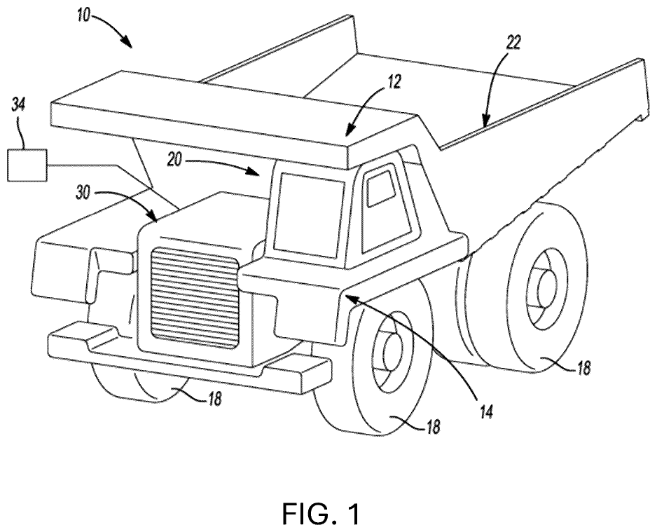

FIG. 1 shows a vehicle 10 powered by a liquid hydrogen fuel cell energy system 34. For example, the liquid hydrogen fuel cell energy system 34 may power one or more motors 30 of the vehicle 10. The motor(s) 30 may include drive motor(s) that operate or drive a plurality of wheels 18 for moving the vehicle across terrain or a ground surface. The liquid hydrogen fuel cell energy system 34 may provide a source of fuel, e.g., liquid hydrogen, to power the vehicle 10, e.g., the motor(s) 30. The use of liquid hydrogen as the source of fuel may provide a volume of fuel supply that can power the vehicle 10, e.g., the motor(s) 30, for prolonged periods, e.g., periods that significantly exceed the current 2.75 hour operational limit of large industrial hydrogen fueled vehicles. Further, the use of liquid hydrogen as the source of fuel may provide a cleaner burning fuel supply the ensures compliance with greenhouse gas requirements.

The vehicle 10 may be in the form of an earth mover or mining vehicle, e.g., a haul vehicle 12. In the illustrated embodiment, the haul vehicle 12 may be a dump truck that may travel throughout a work site, such as a mine or a quarry, and may transport a load contained in a vessel or dump body 22. In some embodiments, the haul vehicle 12 may transport material and/or objects excavated at the work site via the dump body 22. In some embodiments, the vehicle 10 shown in FIG. 1 may be an off-highway mining truck. However, it will be appreciated that the principles of the present disclosure are applicable to other types of industrial or heavy-duty vehicles including wheeled, tracked, or rail vehicles, for example, that are configured for use in the mining, construction, or transportation industries, for example. The vehicle 10 may be an unmanned truck or vehicle that operates in an autonomous manner without depending on a driving operation by a driver or may be a manned truck or vehicle that operates on the basis of a driving operation by a driver. In some embodiments, the vehicle 10 may be a manned truck or vehicle that is operable via controls located in an operator cab 20.

The vehicle 10 has a vehicle body 14 (e.g., a vehicle frame or chassis) supported for movement via the plurality of wheels 18. The wheels 18 may be operable or drivable via the motor(s) 30 to move the vehicle 10 across terrain or a ground surface. The vehicle body 14 may include or support the operator cab 20 that defines an operator compartment (not separately labeled).

The dump body 22 may be supported for movement (e.g., pivoting or tilting) relative to the vehicle body 14. The dump body 22 may be movable (e.g., tiltable or pivotable) relative to the vehicle body 14 about a pivot disposed at or near a rear end of the vehicle body 14. An actuation system, e.g., a hydraulic actuation system, may be configured to move (e.g., tilt or pivot) the dump body 22 relative to the vehicle body 14 between a first position (e.g., a load position and/or travel position, shown in FIG. 1) and a second position (e.g., an unload or dump position). For example, the actuation system may be configured to tilt or pivot the dump body 22 relative to the vehicle body 14 between the first position and the second position (e.g., tilt or pivot from the first position to the second position) while performing a dumping operation and a lowering operation.

The plurality of wheels 18 may be operable or drivable via the motor(s) 30 to cause the vehicle 10 to travel, e.g., forward and/or backward, across terrain or a ground surface. The motor(s) 30 may be configured to drive and/or retard one or more of the wheels 18. The motor(s) 30 can be respectively associated with individual ones of the wheels 18. In some embodiments, the motor(s) 30 include electric motor(s).

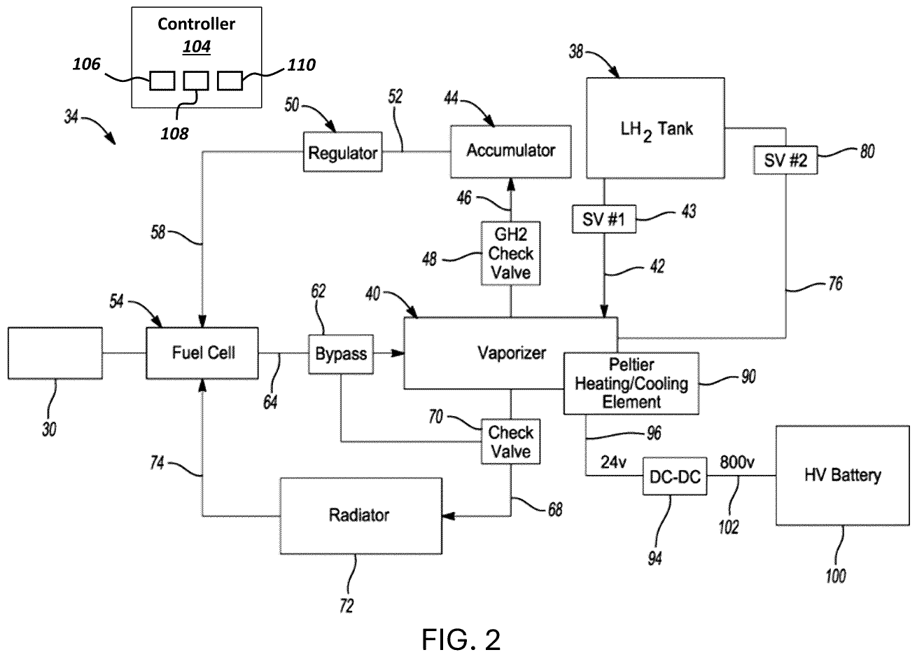

The motor(s) 30 may be powered via the liquid hydrogen fuel cell energy system 34, also referred to as a liquid hydrogen fuel cell power system. The liquid hydrogen fuel cell energy system 34 may be supported by the vehicle body 14 and/or by an auxiliary platform or structure of the vehicle 10. Referring to FIG. 2, the liquid hydrogen fuel cell energy system 34 may include a liquid hydrogen storage container or tank 38 connected to a heat exchanger or vaporizer 40 via a liquid hydrogen delivery conduit 42. The heat exchanger 40 may be operable to convert or vaporize liquid hydrogen from the liquid hydrogen storage tank 38 to hydrogen gas (also referred to as gaseous hydrogen). A control valve 43 may be positioned on the hydrogen delivery conduit 42 for controlling flow of the liquid hydrogen from the liquid hydrogen storage tank 38 to the heat exchanger 40. The control valve 43 may include, for example, a solenoid valve.

As shown in FIG. 2, in some embodiments, the liquid hydrogen storage tank 38 and the heat exchanger 40 may be positioned at different elevations or heights. In this way, a potential energy of the liquid hydrogen storage tank 38 may be different than a potential energy of the heat exchanger 40. For example, the liquid hydrogen storage tank 38 may include a first potential energy and the heat exchanger 40 may include a second potential energy, and the liquid hydrogen storage tank 38 may be elevated or raised relative to the heat exchanger 40 such that the first potential energy is greater than the second potential energy. In some embodiments, the liquid hydrogen may flow from the liquid hydrogen storage tank 38 to the heat exchanger 40 via gravity.

The heat exchanger 40 may be fluidly connected to an accumulator 44 via a first gas line 46. The accumulator 44 may receive and store a volume of the gaseous hydrogen from the heat exchanger 40. A check valve 48 may be positioned on the first gas line 46. The check valve 48 may limit or prevent gaseous hydrogen from passing from accumulator 44 back to the heat exchanger 40.

A regulator 50 may be connected to the accumulator 44 via a second gas line 52. The regulator 50 may control an operating parameter of hydrogen gas flowing from the accumulator 44 to to a fuel cell 54 via a regulator line 58. For example, the regulator 50 may control a pressure of the hydrogen gas flowing from the accumulator 44 to the fuel cell 54 via the regulator line 58. In some embodiments, the regulator 50 may control a temperature of the hydrogen gas flowing from the accumulator 44 to the fuel cell 54 via the regulator line 58. The fuel cell 54 may be positioned to provide power to the motor(s) 30.

The fuel cell 54 may be configured to generate electrical energy via a chemical reaction (e.g., an electrochemical reaction) between the hydrogen gas from the regulator line 58 and oxygen. In some embodiments, the oxygen may be supplied via ambient air or a dedicated oxygen source of the system 34. In an example operation of the fuel cell 54, gaseous hydrogen may be supplied to the fuel cell 54 and introduced at an anode side of the fuel cell 54. The gaseous hydrogen may be catalytically dissociated into protons and electrons. The protons may pass through an electrolyte membrane or separator to a cathode side of the fuel cell 54, while the electrons may travel through an external circuit, thereby generating an electric current that can be used to power the motor(s) 30 of the vehicle 10. At the cathode, the protons, electrons, and oxygen may recombine to form water as a byproduct. This process may allow the fuel cell 54 to efficiently convert the chemical energy stored in hydrogen gas into usable electrical energy with water and heat as the primary exhaust products. The generated electrical energy may be delivered directly to the motor(s) 30 or stored in a battery 100 for subsequent use in powering the vehicle 10.

In some embodiments, the fuel cell 54 may be fluidly connected to heat exchanger 40 via a bypass 62. A bypass line 64 may extend between the fuel cell 54 and the bypass 62. Depending on the operation of liquid hydrogen fuel cell energy system 34, excess hydrogen gas in the fuel cell 54 may flow back to the heat exchanger 40 via the bypass line 64. The bypass 62 may include a control valve operable to allow or limit (e.g., prevent or inhibit) flow of the hydrogen gas from the fuel cell 54 toward to the heat exchanger 40 via the bypass line 64.

The heat exchanger 40 may also be fluidly connected to a second heat exchanger, e.g., a radiator 72, via an unconverted liquid line, e.g., a radiator line 68. The radiator 72 may receive unconverted liquid hydrogen from the heat exchanger 40 and may be operable to heat the unconverted liquid hydrogen and yield gaseous hydrogen. Hydrogen gas from the radiator 72 may be supplied to the fuel cell 54 via a third gas line 74. A check valve 70 may be positioned on the radiator line 68. The check valve 70 may limit or prevent unconverted liquid hydrogen and/or gaseous hydrogen from passing from the radiator 72 back to the heat exchanger 40. In some embodiments, the check valve 70 may also be connected to a branch of the bypass line 64 from the bypass 62.

As an illustrative example of operating the liquid hydrogen fuel cell energy system 34, when liquid hydrogen is being processed via the heat exchanger 40 and hydrogen gas is actively supplied to the fuel cell 54, excess hydrogen gas may pass from the fuel cell 54 through the bypass 62 and enter the heat exchanger 40. When hydrogen gas is not actively being produced via the heat exchanger 40, e.g., when the liquid hydrogen fuel cell energy system 34 is in a cooling stage, the heat exchanger 40 may discharge remaining unconverted liquid hydrogen via the radiator line 68 through the check valve 70 to the radiator 72. The liquid hydrogen may be heated via the radiator 72, converted or vaporized into hydrogen gas, and flow toward the fuel cell 54 via the third gas line 74.

In some embodiments, liquid hydrogen may be stored in the liquid hydrogen storage tank 38 at a temperature of around −252° C. and a pressure of between about 4 bar to about 5 bar. The control valve 43 may be operated (e.g., opened) to allow liquid hydrogen to flow from the liquid hydrogen storage tank 38 to the heat exchanger 40 via the liquid hydrogen delivery conduit 42. The liquid hydrogen is heated via the heat exchanger 40, which may create an increase in pressure (e.g., up to about 150 bar) and may convert or vaporize the liquid hydrogen to gaseous hydrogen that passes to accumulator 44 via the first gas line 46. The accumulator 44 may store an amount of gaseous hydrogen at a pressure of about 150 bar. From the accumulator 44, the gaseous hydrogen may be regulated or controlled via the regulator 50 to a selected set point target fuel cell injection pressure and temperature. For example, the gaseous hydrogen may be regulated via the regulator 50 to a pressure of between about 12 bar to about 16 bar and a temperature of between about −45° C. to about −85° C. The fuel cell 54 may generate electrical energy from the gaseous hydrogen to power the motor(s) 30.

In some embodiments, during vaporization and pressure build up in heat exchanger 40, some hydrogen gas may be purged from the heat exchanger 40 to the liquid hydrogen storage tank 38 via a pressure relief circuit including a pressure relief line, e.g., a return line 76. A pressure relief valve 80 may be positioned on the return line 76 for controlling flow of the purged hydrogen gas from the heat exchanger 40 to the liquid hydrogen storage tank 38. The pressure relief valve 80 may include, for example, a solenoid valve. In some embodiments, the pressure relief valve 80 may be controlled or operated (e.g., opened) to reduce pressure in the heat exchanger 40, e.g., to ambient pressure.

In some embodiments, a cooling stage may be initiated at the heat exchanger 40. During the cooling stage, the heat exchanger 40 may be cooled down, e.g., via ambient air, via passing liquid hydrogen in a heat exchange relationship with the heat exchanger 40, and/or via use of an external cooling device in preparation for another cycle. Following the cooling stage, liquid hydrogen may flow, e.g., under force of gravity, from the liquid hydrogen storage tank 38 to the heat exchanger 40 and the vaporization process to produce gaseous hydrogen may repeat.

Although a single heat exchanger 40 is depicted in FIG. 1, multiple heat exchangers may be used in some embodiments. The heat exchangers may be operated in series and/or in parallel. In some embodiments, the system 34 may include multiple heat exchangers arranged in parallel which may be used to maintain an uninterrupted flow of hydrogen gas to the fuel cell 54.

In some embodiments, the liquid hydrogen fuel cell energy system 34 may include a hydrogen conversion device 90 arranged in a heat exchange relationship with the heat exchanger 40. The hydrogen conversion device 90 may facilitate converting or vaporizing liquid hydrogen to gaseous hydrogen. In some embodiments, the hydrogen conversion device 90 comprises an electrically powered device mounted to a surface of the heat exchanger 40. For example, the hydrogen conversion device 90 may include a Peltier device that powers the heat exchanger 40. The Peltier device 90 may provide heat to vaporize the liquid hydrogen and may also operate to cool the heat exchanger 40 in preparation for receiving additional liquid hydrogen.

The hydrogen conversion device 90, e.g., the Peltier device, may be connected to a step down transformer 94 via a low voltage line 96. The step down transformer 94 may reduce supply voltage provided by the battery 100 through a high voltage line 102. The battery 100 may be connected to the motor(s) 30 via the fuel cell 54 to provide energy to power the vehicle 10.

The battery 100 may include a high voltage power source. For example, in some embodiments, the battery 100 may be an approximately 800 volt (V) battery. In some embodiments, the Peltier device 90 may operate on about 12 V or about 24 V.

The liquid hydrogen fuel cell energy system 34 may include a controller 104. The controller 104 may be operable to control operations of various components of the system 34, e.g., the control valve 43, the bypass 64, and the pressure relief valve 80. The controller 104 may also be operable to control operation of the heat exchanger 40, the regulator 50, the fuel cell 54, the radiator 72, the hydrogen conversion device 90, the step down transformer 94, the battery 100, among other components. Although a single controller 104 is shown in FIG. 2, more than one controller 104 may be included. In some embodiments, various controllers may be included and dedicated to various components of the system 34, and the controllers may be connected in communication with one another.

The controller 104 may include at least one processor 106, at least one memory device 108, and an input/output (I/O) interface 110 for monitoring and controlling various components of the liquid hydrogen fuel cell energy system 34. The processor(s) 106 may execute instructions stored in the memory device(s) 108 to implement control algorithms for regulating or controller the operation of the components of the system 34, such as the control valve 43, the bypass 64, the pressure relief valve 80, the heat exchanger 40, the regulator 50, the fuel cell 54, the radiator 72, the hydrogen conversion device 90, the step down transformer 94, the battery 100, among others. The I/O interface 110 may be configured to receive sensor signals indicative of system parameters (e.g., temperature, pressure, flow rates, voltage, and current) and to transmit control signals to actuators, valves, and other system elements. The memory device(s) 108 may store operating parameters, calibration data, and executable instructions for the processor(s) 106, enabling the controller 104 to adapt to changing conditions and provide coordinated control for the system 34.

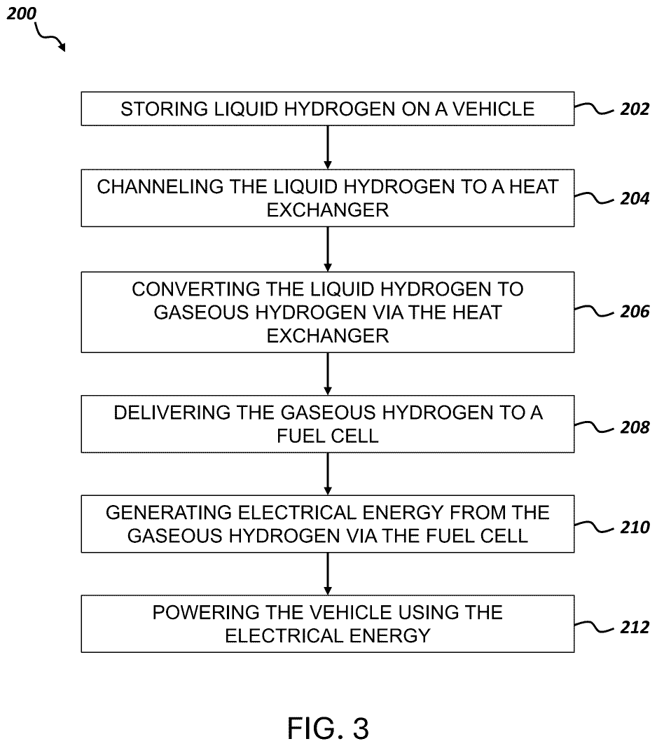

Referring now to FIG. 3, an example method 200 for powering a vehicle, e.g., the vehicle 10 of FIG. 1, using a liquid hydrogen fuel cell energy system, e.g., the system 34 of FIG. 2, is provided. The method 200 may include storing 202 an amount of liquid hydrogen on the vehicle, e.g., in the liquid hydrogen storage tank 38. The method 200 may also include channeling 204 at least a portion of the amount of liquid hydrogen that is stored 202 on the vehicle to a heat exchanger, e.g., the heat exchanger 40. The method 200 may also include converting 206, e.g., vaporizing, the liquid hydrogen that is channeled 204 to the heat exchanger to gaseous hydrogen via the heat exchanger. The method 200 may also include delivering 208 the gaseous hydrogen to a fuel cell, e.g., the fuel cell 54. The method 200 may also include generating 210 electrical energy from the gaseous hydrogen via the fuel cell, e.g., via a chemical or electrochemical reaction between hydrogen gas and oxygen. The method 200 may also include powering 212 the vehicle with the electrical energy that is generated 210 from the gaseous hydrogen.

In some embodiments, the method 200 may further include channeling the gaseous hydrogen from the heat exchanger to an accumulator. In some embodiments, the method 200 may further include channeling the gaseous hydrogen from the accumulator through a regulator, e.g., the regulator 50, before delivering 208 the gaseous hydrogen to the fuel cell. For example, the method 200 may include regulating or controlling a pressure, a temperature, or other operating parameter of the gaseous hydrogen via the regulator before delivering 208 the gaseous hydrogen to the fuel cell. In some embodiments, the regulator may be a pressure regulator and the method 200 may include regulating or controlling a pressure of the gaseous hydrogen via the pressure regulator before delivering 208 the gaseous hydrogen to the fuel cell. In some embodiments, the gaseous hydrogen delivered 208 to the fuel cell may have a pressure of between about 12 bar to about 16 bar and a temperature of between about −45° C. to about −85° C.

In some embodiments of the method 200, converting 206 the liquid hydrogen to gaseous hydrogen may include raising a temperature of the liquid hydrogen via the heat exchanger. In some embodiments, raising the temperature of the liquid hydrogen via the heat exchanger may be facilitated via an electrically powered device arranged in a heat exchange relationship with the heat exchanger. In certain embodiments, the electrically powered device includes a Peltier device. In some embodiments, raising the temperature of the liquid hydrogen via the heat exchanger includes channeling a heat transfer liquid in a heat exchange relationship with the heat exchanger. In some embodiments, after channeling the gaseous hydrogen to the accumulator, the heat exchanger may be cooled, e.g., via exposure to ambient air, via passing liquid hydrogen in a heat exchange relationship with the heat exchanger, and/or via an external cooling device. In some embodiments, channeling the liquid hydrogen to the heat exchanger includes channeling a first portion of the liquid hydrogen to a first heat exchanger and channeling a second portion of the liquid hydrogen to a second heat exchanger.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The configurations of the embodiments described above can be incorporated in any combination. In other embodiments, other configurations are possible. For example, those of skill in the art will recognize, according to the principles and concepts disclosed herein, that various combinations, sub-combinations, and substitutions of the components discussed above can provide a system or a method incorporating aspects and principles of the present disclosure.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A liquid hydrogen fuel cell power system for a vehicle comprising:
a liquid hydrogen storage container;
a heat exchanger fluidly connected to the liquid hydrogen storage container, the heat exchanger configured to convert liquid hydrogen from the liquid hydrogen storage container to gaseous hydrogen; and
a fuel cell fluidly connected to the heat exchanger, the fuel cell configured to generate electrical energy from the gaseous hydrogen, wherein the electrical energy is used to power the vehicle.

2. The liquid hydrogen fuel cell power system of claim 1, wherein the liquid hydrogen storage container includes a first potential energy, the heat exchanger includes a second potential energy, and the second potential energy is lower than the first potential energy.

3. The liquid hydrogen fuel cell power system of claim 2, further comprising a liquid hydrogen delivery conduit extending between the liquid hydrogen storage container and the heat exchanger, wherein the liquid hydrogen is channeled through the liquid hydrogen delivery conduit from the liquid hydrogen storage container to the heat exchanger via gravity.

4. The liquid hydrogen fuel cell power system of claim 1, further comprising an accumulator fluidly connected between the heat exchanger and the fuel cell, wherein the accumulator is configured to store the gaseous hydrogen from the heat exchanger.

5. The liquid hydrogen fuel cell power system of claim 4, further comprising a regulator fluidly connected between the accumulator and the fuel cell, wherein the regulator is configured to control an operating parameter of the gaseous hydrogen upstream from the fuel cell.

6. The liquid hydrogen fuel cell power system of claim 1, further comprising a hydrogen conversion device arranged in a heat exchange relationship with the heat exchanger, wherein the hydrogen conversion device is configured to facilitate converting the liquid hydrogen to the gaseous hydrogen.

7. The liquid hydrogen fuel cell power system of claim 6, wherein the hydrogen conversion device comprises an electrically powered device mounted to the heat exchanger.

8. The liquid hydrogen fuel cell power system of claim 7, wherein the electrically powered device comprises a Peltier device.

9. The liquid hydrogen fuel cell power system of claim 7, wherein the electrically powered device is connected to a battery.

10. The liquid hydrogen fuel cell power system of claim 9, wherein the battery comprises a high voltage power source.

11. The liquid hydrogen fuel cell power system of claim 10, further comprising a step down transformer electrically connected between the high voltage power source and the electrically powered device.

12. The liquid hydrogen fuel cell power system of claim 1, wherein the heat exchanger is a first heat exchanger, and the liquid hydrogen fuel cell power system further comprises a second heat exchanger downstream from the first heat exchanger and configured to receive unconverted liquid hydrogen from the first heat exchanger.

13. The liquid hydrogen fuel cell power system of claim 12, wherein the second heat exchanger is fluidly connected to the fuel cell.

14. The liquid hydrogen fuel cell power system of claim 12, further comprising a check valve positioned between the first heat exchanger and the second heat exchanger.

15. The liquid hydrogen fuel cell power system of claim 1, further comprising a bypass positioned between the heat exchanger and the fuel cell.

16. The liquid hydrogen fuel cell power system of claim 1, further comprising a pressure relief circuit fluidly connected to the heat exchanger.

17. A vehicle including the liquid hydrogen fuel cell power system of claim 1.

18. A method of powering a vehicle comprising:
storing liquid hydrogen on the vehicle;
channeling at least a portion of the liquid hydrogen to a heat exchanger;
converting the liquid hydrogen to gaseous hydrogen via the heat exchanger;
delivering the gaseous hydrogen to a fuel cell;
generating electrical energy from the gaseous hydrogen via the fuel cell; and
powering the vehicle with the electrical energy.

19. The method of claim 18, further comprising channeling the gaseous hydrogen from the heat exchanger to an accumulator.

20. The method of claim 18, wherein converting the liquid hydrogen to the gaseous hydrogen includes raising a temperature of the liquid hydrogen via the heat exchanger.
